(19) United States
(12) Patent Application Publication
(10) Pub. No.: US 2025/0218345 A1
(43) Pub. Date: Jul. 3, 2025

(54) Driving circuit for display panel

(71) Applicant: SITRONIX TECHNOLOGY CORP., Hsinchu County (TW)

(72) Inventor: Chung-Hsin Su, Hsinchu County (TW)

(21) Appl. No.: 18/826,673

(22) Filed: Sep. 6, 2024

Related U.S. Application Data
(60) Provisional application No. 63/536,727, filed on Sep. 6, 2023.

(51) Int. Cl. G09G 3/32

(52) U.S. Cl. CPC G09G 3/32; G09G 2310/08; G09G 2320/02; G09G 2320/0673

(57) ABSTRACT

The present application provides a driving circuit for display panel, which comprises a current generating circuit and a current control circuit. The current generating circuit generates at least one current for driving light-emitting diodes. The current control circuit controls the current generating circuit to generate current. In an initial stage, the current control circuit controls the current generating circuit to generate smaller current. After the initial stage, the current control circuit controls the current generating circuit to generate larger current. In addition, the current control circuit controls the current generating circuit to generate current in a plurality of cycles. Each cycle includes the initial stage. The current control circuit controls the current generating circuit to generate current in the initial stage of a cycle for every N cycles of the cycles, wherein N is greater than 2.

### FIELD OF THE INVENTION

The present application relates to a driving circuit, in particular to a driving circuit for display panel.

### BACKGROUND OF THE INVENTION

Display devices have become essential equipment for electronic products to display information. Display devices have developed from liquid-crystal display devices to light-emitting diode display devices, such as sub-millimeter light-emitting diode (mini LED) display devices and micro light-emitting diode (micro LED) display devices. As a display element, light-emitting diodes may improve the display quality of the display device. The brightness of the light generated by the existing light-emitting diode display devices cannot be close to the Gamma curve. That is, the brightness of the gray scale displayed by the existing light-emitting diode display devices cannot be close to the Gamma curve, such as the Gamma2.2 curve, especially for the low grayscale. Consequently, the brightness limits the display quality of the light-emitting diode display devices.

In view of the above-mentioned problems in the prior art, the present application proposes a driving circuit for display panel, which drives light-emitting diodes to generate light. The brightness of the light may be close to the Gamma curve, and thereby improving the display quality of light-emitting diode display devices.

### SUMMARY OF THE INVENTION

An objective of the present application is to provide a driving circuit for display panel. In the initial driving stage, a low electrical energy is used to drive LEDs to generate light. Thereby, the brightness of the light corresponding to low grayscale may be close to the Gamma curve and hence improving the display quality of LED display devices.

The present application provides a driving circuit for display panel, which comprises a current generating circuit and a current control circuit. The current generating circuit generates a first current and a second current with the first current smaller than the second current. The current control circuit controls the current generating circuit to generate the first current and the second current according to a clock signal. The current control circuit controls the current generating circuit to generate the first current in an initial stage according to the clock signal. After the initial stage, the current control circuit controls the current generating circuit to generate the first current and the second current.

The present application further provides a driving circuit for display panel, which comprises a current generating circuit and a current control circuit. The current generating circuit generates at least one current. The current control circuit controls the current generating circuit to generate the current in a plurality of cycles according to a clock signal. Each cycle includes an initial stage. The current control circuit controls the current generating circuit to generate current in the initial stage of a cycle for every N cycles of the cycles, where N is greater than 2.

The present application further provides a driving circuit for display panel, which comprises a current generating circuit and a current control circuit. The current generating circuit generates at least one current. The current control circuit controls the current generating circuit to generate current in a plurality of cycles according to a clock signal. Each cycle includes a plurality of sub-cycles. Each sub-cycle includes an initial stage. The current control circuit controls the current generating circuit to generate current in the initial stage of one of the sub-cycles.

### BRIEF DESCRIPTION OF DRAWINGS

FIG. 1 shows a schematic diagram of the driving architecture according to an embodiment of the present application;

FIG. 2 shows a block diagram of the controller and the driver according to an embodiment of the present application;

FIG. 3 shows a block diagram of the driving circuit according to an embodiment of the present application;

FIG. 4 shows a timing diagram of the driving circuit according to an embodiment of the present application;

FIG. 5 shows a Gamma 2.2 grayscale curve;

FIG. 6A shows a timing diagram of the driving circuit according to an embodiment of the present application;

FIG. 6B shows a timing diagram of the driving circuit according to an embodiment of the present application;

FIG. 7A shows a timing diagram of the driving circuit according to an embodiment of the present application;

FIG. 7B shows a timing diagram of the driving circuit according to an embodiment of the present application;

FIG. 8 shows a block diagram of the controller and the driver according to an embodiment of the present application;

FIG. 9 shows a timing diagram of the driving circuit according to an embodiment of the present application;

FIG. 10 shows a block diagram of the controller and the driver according to an embodiment of the present application;

FIG. 11 shows a timing diagram of the driving circuit according to an embodiment of the present application; and

FIG. 12 shows a timing diagram of the driving circuit according to an embodiment of the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

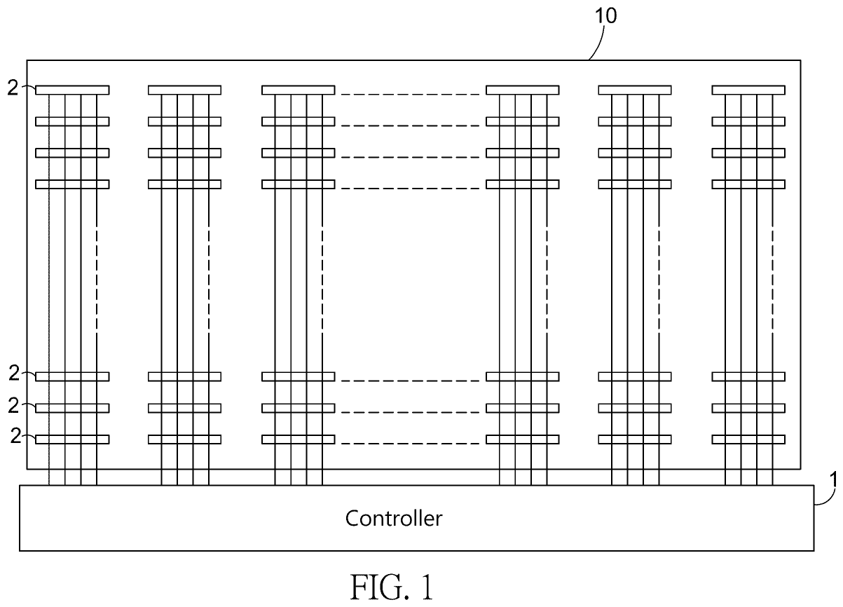

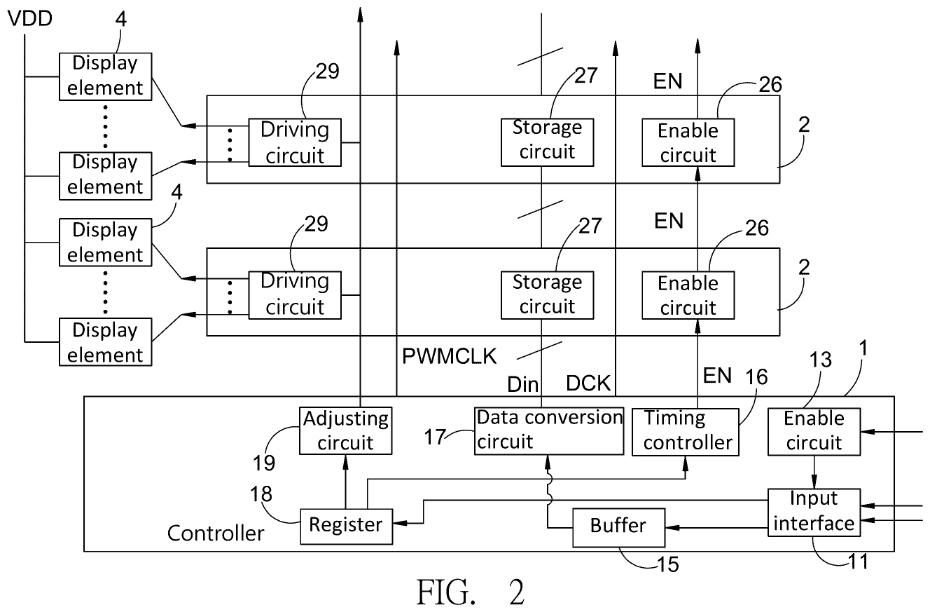

Please refer to FIG. 1 and FIG. 2. FIG. 1 shows a schematic diagram of the driving architecture according to an embodiment of the present application; FIG. 2 shows a block diagram of the controller and the driver according to an embodiment of the present application. As shown in the figures, the driving architecture includes a controller 1 and a plurality of drivers 2 for driving the subpixels of a plurality of pixels of the display panel 10 to display images. The drivers 2 are arranged in a plurality of rows. Each driver 2 is coupled to a plurality of display elements 4 for driving the display elements 4 to emit light. The display elements 4 are the subpixels. According to an embodiment of the present application, the display elements 4 may be sub-millimeter LEDs, micro LEDs, or LEDs.

The controller 1 is coupled to the drivers 2 and transmits input data Din, a clock signal DCK, a clock signal PWMCLK, and an enable signal EN to the drivers 2. According to an embodiment of the present application, the drives 2 are all coupled to a bus. The controller 1 transmits the input data Din to the bus. The drivers 2 receive the input data Din via the bus. The input data Din may be serial data and include a plurality of pixel data. The drivers 2 receive the input data Din at different times. Thereby, the pixel data received by the drivers 2 are different. For example, when a driver 2 receives the input data Din, the other drivers 2 do not receive the input data Din. After this driver 2 receives a pixel data of the input data Din, another driver 2 is driven to receive the input data Din for receiving other pixel data of the input data Din. Since the above two drivers 2 receive the input data Din at different times, the pixel data of the input data Din received by the two drivers 2 will be different for driving a plurality of display elements 4 of the display panel 10 to generate light with different brightness. According to an embodiment of the present application, the controller 1 may be an independent chip. Because the drivers 2 are arranged in a plurality of rows, the pixels arranged in a matrix on the display panel 10 may be controlled by the drivers 2.

Please refer to FIG. 2 again. The controller 1 includes an input interface 11, an enable circuit 13, a buffer 15, a timing controller 16, a data conversion circuit 17, a register 18, and an adjusting circuit 19. The controller 1 is coupled to a host, for example, the microprocessor of an electronic product, for receiving the input data Din, signals, control commands, or relevant control parameters. The input interface 11 receives the input data Din, signals, control commands, or control parameters. The enable circuit 13 is coupled to the input interface 11 and enables the input interface 11 according to an enable signal received for driving the input interface 11 to receive the input data Din, signals, control commands, or control parameters.

The buffer 15 is coupled to the input interface 11 and the data conversion circuit 17. The input interface 11 transmits the input data Din to the buffer 15. The buffer 15 buffers the input data Din and transmits the buffered input data Din to the data conversion circuit 17 for converting the input data Din, for example, converting 6-bit data to 10-bit data or converting 8-bit data to 12-bit data. The data conversion circuit 17 transmits the converted input data Din to the drivers 2 via the bus. According to an embodiment of the present application, the data conversion circuit 17 may be integrated in the timing controller 16. The register 18 is coupled to the input interface 11, the timing controller 16, and the adjusting circuit 19. The input interface 11 transmits the control parameters to the register 18. The register 18 stores the control parameters and provides the control parameters to the timing controller 16 and the adjusting circuit 19. The timing controller 16 generates an enable signal EN and a clock signal DCK and transmits them to the drivers 2. The adjusting circuit 19 generates an adjusting signal to the drivers 2 according to the control parameters for adjusting the amplitude of a plurality of driving signals generated by the drivers 2. According to an embodiment of the present application, the adjusting signal may be a voltage. By changing the amplitude of the voltage, the amplitude of the driving signals may be adjusted.

Please refer to FIG. 2 again. Each driver 2 includes an enable circuit 26, a storage circuit 27, and a driving circuit 29. The enable circuit 26 receives the enable signal EN and enables the storage circuit 27 according to the enable signal EN to receive the input data Din according to the clock signal DCK. The driving circuit 29 is coupled to the storage circuit 27 and the display elements 4 and generates a plurality of driving signals according to the clock signal PWMCLK and the input data Din received by the storage circuit 27 for driving the display elements 4 to generate light for displaying images. After the first driver 2 drives the display elements 4, the enable circuit 26 of the first driver 2 will disable the storage circuit 27 of the first driver 2 and transmit the enable signal EN to the enable circuit 26 of the second driver 2 to perform above operations for driving the display elements 4 coupled to the second driver 2.

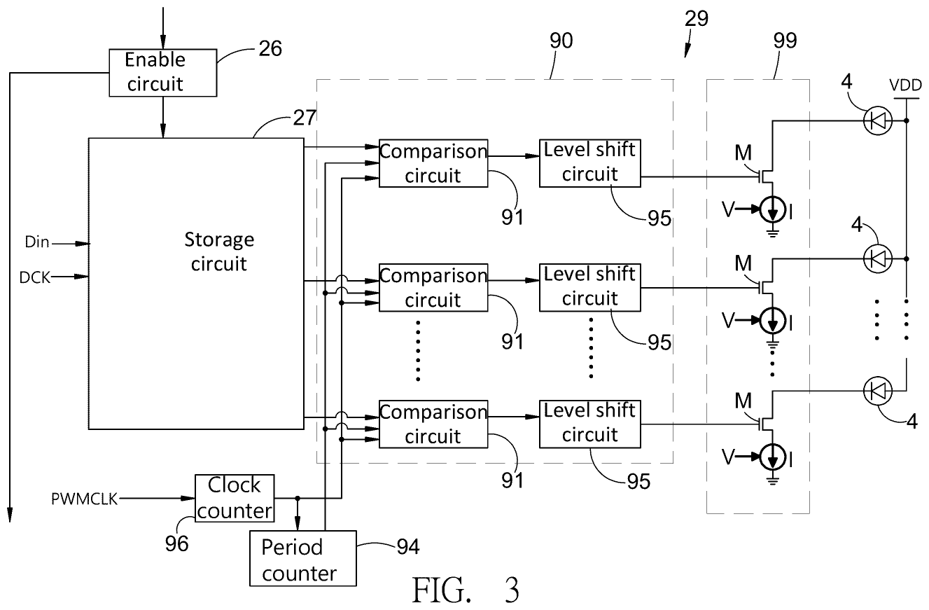

Please refer to FIG. 3, which shows a block diagram of the driving circuit according to an embodiment of the present application. As shown in the figure, the storage circuit 27 is coupled to the enable circuit 26 and receives the input data Din and the clock signal DCK. The enable circuit 26 enables the storage circuit 27 according to the received enable signal for driving the storage circuit 27 to receive and store the input data Din according to the clock signal DCK. The driving circuit 29 includes a current control circuit 90, a clock counter 96, and a current generating circuit 99. One terminal of the display elements 4 is coupled to a supply voltage VDD with the other terminal coupled to the current generating circuit 99. The current generating circuit 99 generates current as the driving signal for driving the display elements 4. The current generating circuit 99 includes a plurality of switches M and a plurality of current sources I. One terminal of each switch M is coupled to the other terminal of each display element 4, respectively. Each current source I is coupled between the other terminal of each switch M and a ground. The current source I may be controlled by a reference voltage V for adjusting the density of the current generated by the current source I. According to an embodiment of the present application, the adjusting signal generated by the adjusting circuit 19 may be the reference voltage V.

Please refer again to FIG. 3. The current control circuit 90 includes a plurality of comparison circuits 91 and a plurality of level shift circuits 95. The comparison circuits 91 are coupled to the storage circuit 27 and the clock counter 96. The clock counter 96 receives the clock signal PWMCLK and counts the clock of the clock signal PWMCLK for outputting a counting signal, which is a count value. The counting signal changes according to the count of the clock counter 96. According to an embodiment of the present application, the present application further comprises a clock generating circuit for generating the clock signal PWMCLK. In addition, the frequency of the clock signal PWMCLK may be changed. Each comparison circuit 91 receives and compares the counting signal and the pixel data of the input data Din stored in the storage circuit 27. When the pixel data is greater than the counting signal, the comparison circuit 91 outputs a control signal with the driving level, for example the high level. According to another embodiment of the present application, when the pixel data is smaller than the counting signal, the comparison circuit 91 outputs the control signal with the driving level. The level shift circuits 95 are coupled to the comparison circuits 91 and shift the level of the control signals output by the comparison circuits 95. According to an embodiment of the present application, the level shift circuits 95 are not required. It is known from the above description that the comparison circuit 91 is coupled to the current generating circuit 99 for controlling the current generating circuit 99.

The control signal generated by the comparison circuit 91 is used for controlling the switch M of the current generating circuit 99 and generating current. The current flows through the display elements 4 for generating light. According to the above description, it is known that the time when the level of the control signal generated by the comparison circuit 91 remains at the driving level is the driving time, namely, the turn-on time. It is the time for driving the display element 4 and determining the brightness of the display element 4. The brightness is determined by the turn-on time and the current density. According to the present embodiment, the common anode architecture is adopted for driving the display elements 4. Nonetheless, the present application is not limited to the embodiment. Alternatively, the common cathode architecture may be adopted for driving the display elements 4. The details will be illustrated as follows. The clock counter 96 counts based on a fixed number, for example, 4096. Every time the clock counter 96 counts the clocks of the clock signal PWMCLK to 4096, it resets the counting for completing a cycle, meaning that the maximum value of the counting signal is 4096, which is equivalent to 12-bit data. The comparison circuit 91 compares the counting signal and the pixel data for generating the control signal with high level (the driving level). For example, if the pixel data is 1900 and as the value of the counting signal not exceeding 1900, the comparison circuit 91 generates the control signal with the driving level for controlling the current generating circuit 99 to generate current. When the value of the counting signal exceeds 1900, the comparison circuit 91 generates the control signal with the low level until the value of the counting signal is equal to 4096 and completing a cycle.

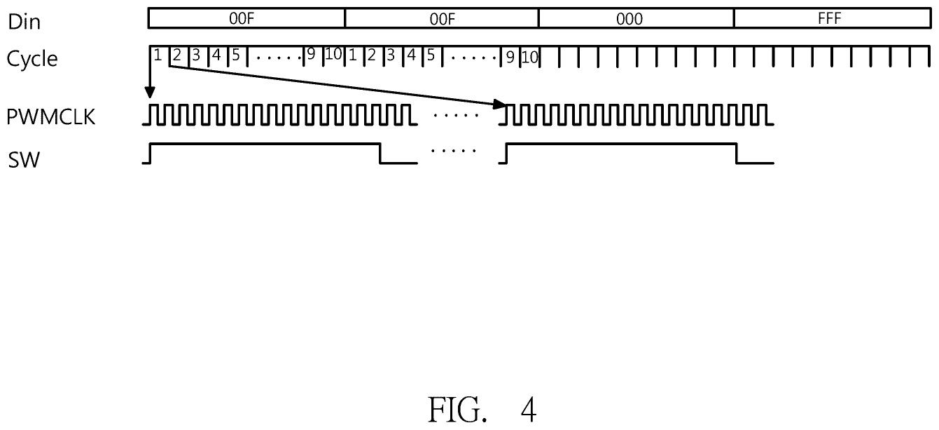

Please refer to FIG. 4, which shows a timing diagram of the driving circuit according to an embodiment of the present application. FIG. 4 presents the timing diagram of the driving circuit driving the same pixel in four frames. According to the present embodiment, a frame includes 10 cycles Cycle, requiring the clock counter 96 to count for 10 times of 4096. It also means that the storage circuit 27 refreshes the pixel data for every 10 cycles Cycle. The present embodiment adopts the 12-bit clock signal PWMCLK to drive the display elements 4 to display 8-bit grayscales (256 grayscales). The first pixel data of the input data Din are 00F. For convenience, assume that 0° F. represent the 15th grayscale being the brightness of the light generated by the display element 4. The control signal SW of the current control circuit 90 will control the current generating circuit 99 to generate current between the first and the 15th clocks of each cycle. In other words, the current control circuit 90 controls the current generating circuit 99 to generate current in the cycles according to the clock signal PWMCLK.

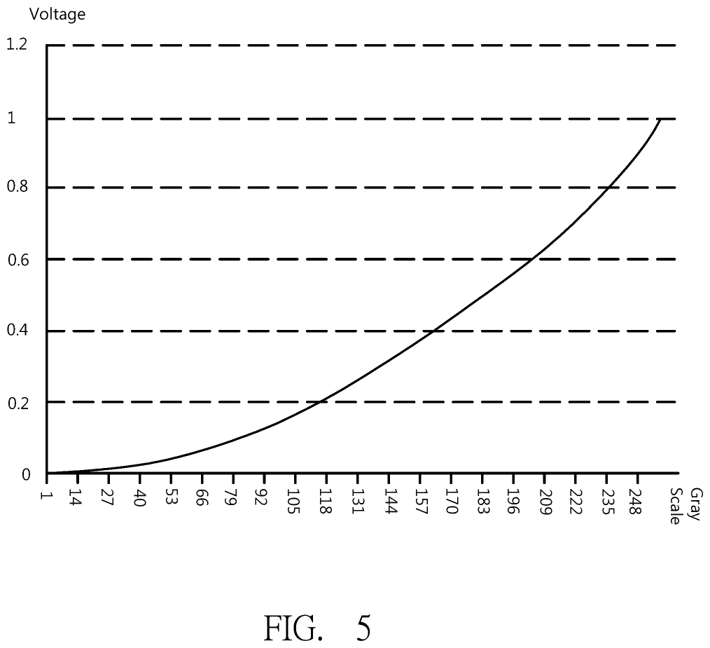

Please refer to FIG. 5, which shows a Gamma2.2 grayscale curve. As shown in the figure, the brightness values of low grayscales, for example, the grayscales 1 to 20, in the Gamma2.2 curve are quite concentrated and close. The present application further discloses other driving circuits for driving display elements to generate light with brightness more complying with the Gamma2.2 curve. In the initial stage of the cycle, the driving circuit according to the present application drives LEDs to generate light with low electrical energy. Thereby, by lowering the brightness in the initial stage, the brightness values of the light corresponding to low grayscales match the Gamma2.2 curve. The initial stage indicates the first several clocks of the clock signal PWMCLK in a cycle. For example, the first to the ninth clocks form the initial stage. The initial stage may be defined according to requirements. Accordingly, each cycle includes the initial stage.

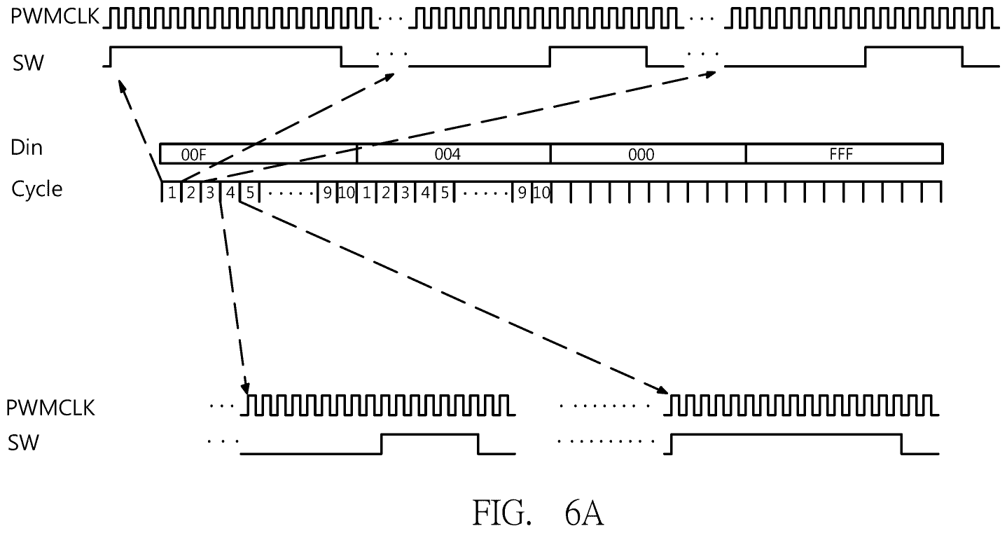

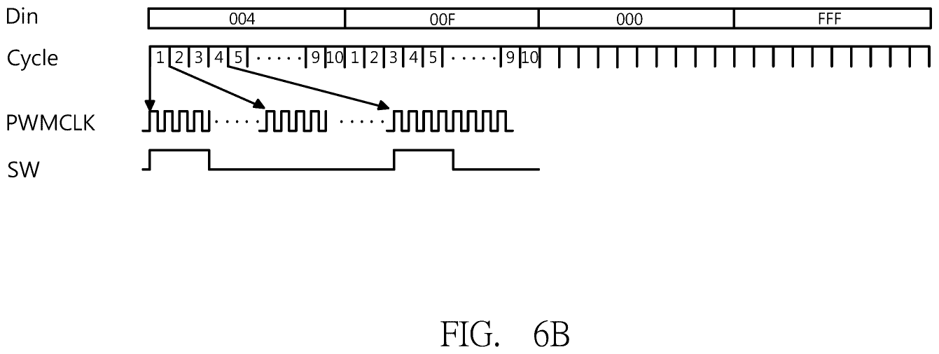

Please refer to FIG. 6A, which shows a timing diagram of the driving circuit according to an embodiment of the present application. The difference between the present embodiment and the one in FIG. 4 is that, according to the present embodiment, the current control circuit 90 will control the current generating circuit 99 to generate current in the initial stage of one of every four cycles. According to the present embodiment, the initial stage is the first to the ninth clocks in the cycle of the clock signal PWMCLK. The first pixel data of the input data Din are 00F. The control signal SW of the current control circuit 90 will control the current generating circuit 99 to generate current in the initial stage and the 10th to the 15th clocks of the first cycle. The control signal SW will not control the current generating circuit 99 to generate current in the initial stage (the first to the ninth clocks) of the second to the fourth cycles. It will control the current generating circuit 99 to generate current only between the 10th and the 15th clocks. The control method of the current control circuit 90 in the fifth cycle is identical to that in the first cycle. According to the above description, the current control circuit 90 may control the current generating circuit 99 to generate current in the initial stage of one of every N cycles. The one cycle to supply current in its initial stage for every N cycle is not limited to a specific one; any for every N cycles will suffice. Besides, N is greater than two and may be set according to requirements.

Please refer to FIG. 6B, which shows a timing diagram of the driving circuit according to an embodiment of the present application. The difference between the present embodiment and the one in FIG. 6A is that, according to the present embodiment, the first pixel data of the input data Din are 004. For convenience, assume that 004 represent the fourth grayscale being the brightness of the light generated by the display element 4. The control signal SW of the current control circuit 90 will control the current generating circuit 99 to generate current between the first and the fourth clocks in the initial stage of the first cycle. The control signal SW will not control the current generating circuit 99 to generate current in the initial stage (the first to the ninth clocks) of the second to the fourth cycles. The control method of the current control circuit 90 in the fifth cycle is identical to that in the first cycle. According to another embodiment of the present application, the current control circuit 90 may control the current generating circuit 99 to generate current in the initial stage of all cycles (namely, 10 cycles) of one of every four frames (including 40 cycles totally) and will not control the current generating circuit 99 to generate current in the initial stage of the cycles of the rest three frames.

Please refer to FIG. 3 again. The driving circuit 29 further comprises a period counter 94 coupled to the clock counter 96 and receiving the counting signal for counting the number of cycles. For example, if the received counting value of the counting signal is 4096, a cycle is counted. The period counter 94 drives the comparison circuit 91 of the current control circuit 90 to output the control signal to control the current generating circuit 99 to generate current in the initial stage of one of every N cycles. For example, in the first and the fifth cycle in FIG. 6A and FIG. 6B, the control signal is output to control the current generating circuit 99 to generate current. Once the period counter 94 counts to a predetermined number of cycles, for example, four cycles, it will restart counting. When it counts to the second to the fourth cycles, the comparison circuit 91 is controlled not to output the control signal in the initial stage. As described above, the comparison circuit 91 compares the counting value and the pixel data for determining the driving time of the cycle. The driving time includes a first driving time and a second driving time. The first driving time is located in the initial stage and is the time for which the current control circuit 90 controls the current generating circuit 99 to generate current in the initial stage. The second driving time is the time for which the current control circuit 90 controls the current generating circuit 99 to generate current beyond the initial stage.

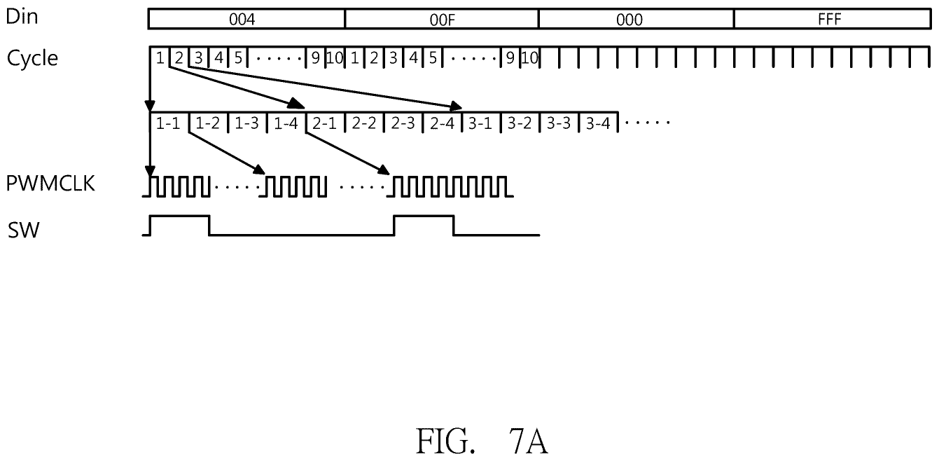

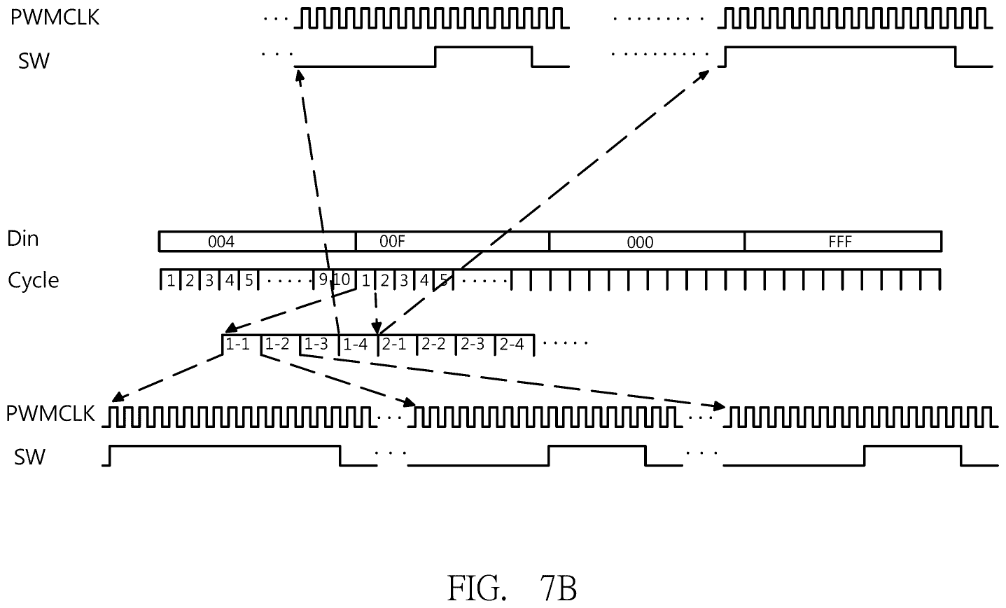

Please refer to FIG. 7A, which shows a timing diagram of the driving circuit according to an embodiment of the present application. The difference between the present embodiment and the one in FIG. 4 is that, according to the present embodiment, each cycle Cycle includes four sub-cycles. Likewise, each sub-cycle corresponds to a fixed number of clocks of the clock signal PWMCLK, for example, 4096 clocks. The frequency of the clock signal PWMCLK according to the present embodiment is four times the frequency of the clock signal PWMCLK according to the embodiment in FIG. 6, equivalently dividing one cycle into four equal parts. The current control circuit 90 will control the current generating circuit 99 to generate current in the initial stage of one of the four sub-cycles. According to the present embodiment, the initial stage corresponds to the first to the ninth clocks of the clock signal PWMCLK in the sub-cycle. The first pixel data of the input data Din are 004. The control signal SW will control the current generating circuit 99 to generate current between the first and the fourth clocks in the initial stage of the first sub-cycle of each cycle Cycle. The control signal SW will not control the current generating circuit 99 to generate current in the initial stage of the second to the fourth sub-cycles.

Please refer to FIG. 7B, which shows a timing diagram of the driving circuit according to an embodiment of the present application. The second pixel data of the input data Din are 00F. The control signal SW will control the current generating circuit 99 to generate current between the first and the ninth clocks in the initial stage and between the 10th and the 15th clocks of the first sub-cycle of each cycle Cycle. The control signal SW will not control the current generating circuit 99 to generate current in the initial stage of the second to the fourth sub-cycles; it will control the current generating circuit 99 to generate current only between the 10th and the 15th clocks. According to the above description, the current control circuit 90 may control the current generating circuit 99 to generate current in the initial stage of one of the sub-cycles. The sub-cycle to supply current in its initial stage is not limited to a specific one; any of the sub-cycles will suffice.

Please refer to FIG. 4 again. The comparison circuit 91 compares the counting value and the pixel data to determine the driving time of the sub-cycle. The driving time includes a first driving time and a second driving time. The first driving time is located in the initial stage and is the time for which the current control circuit 90 controls the current generating circuit 99 to generate current in the initial stage. The second driving time is the time for which the current control circuit 90 controls the current generating circuit 99 to generate current beyond the initial stage. The period counter 94 receives the counting signal for counting the number of sub-cycles. For example, when the counting value of the counting signal is 4096, a sub-cycle is counted. The period counter 94 drives the comparison circuit 91 of the current control circuit 90 to output the control signal to control the current generating circuit 99 to generate current in the initial stage of one of the sub-cycles of the cycle, for example, the first sub-cycle in FIG. 7A and FIG. 7B. Once the period counter 94 counts to a predetermined number of sub-cycles, for example, four sub-cycles, it will restart counting. When it counts to the second to the fourth sub-cycles, the comparison circuit 91 is controlled not to output the control signal in the initial stage.

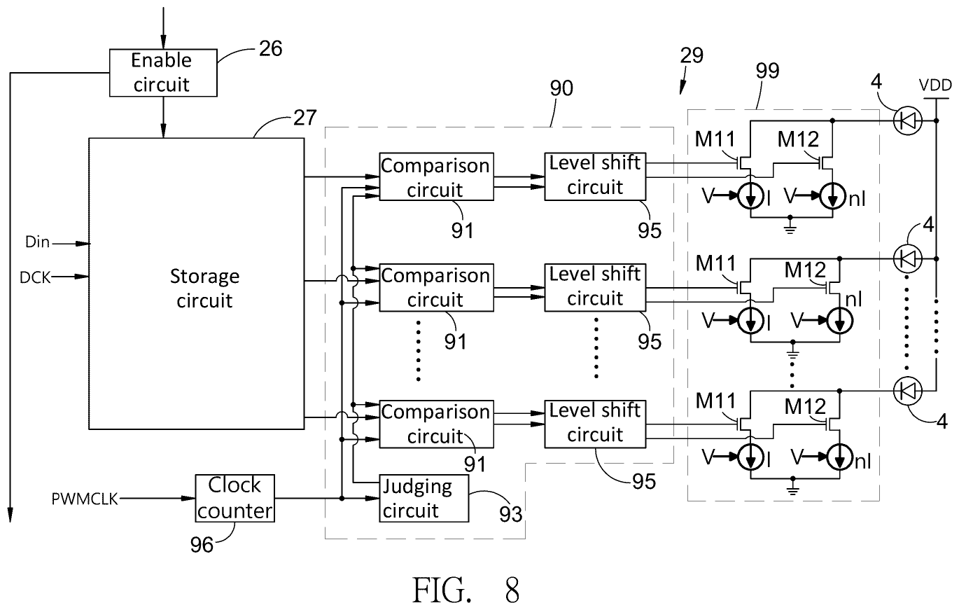

Please refer to FIG. 8, which shows a block diagram of the controller and the driver according to an embodiment of the present application. The current generating circuit 99 according to the present embodiment includes a plurality of first current circuits and a plurality of second current circuits. Each first current circuit includes a switch M11 and a current source I. Each second current circuit includes a switch M12 and a current source nl. The current source I is smaller than the current source nl. The first current circuit generates the first current. The second current circuit generates the second current. The first current is smaller than the second current. According to an embodiment of the present application, the first current may be a quarter of the sum of the first and second currents. The comparison circuit 91 of the current control circuit 90 compares the counting value and the pixel data for determining the driving time of the cycle. The driving time includes a first driving time and a second driving time. The first driving time is located in the initial stage of the cycle. The comparison circuit 91 outputs a first control signal in the first driving time for controlling the first current circuit of the current generating circuit 99 to generate the first current, and outputs the first control signal and a second control signal in the second driving time for controlling the first current circuit and the second current circuit of the current generating circuit 99 to generate the first current and the second current. According to the above description, the current control circuit 90 controls the current generating circuit 99 to generate the first current and the second current according to the clock signal PWMCLK. The current control circuit 90 further includes a judging circuit 93 coupled to the clock counter 96 and the comparison circuits 91 and driving the comparison circuits 91 according to the counting value of the clock signal PWMCLK to control the current generating circuit 99 to generate the first current and the second current. When the counting value reaches the predetermined value, for example, 9, the judging circuit 96 judges that the initial stage has ended and then controls the comparison circuits 91 to output the second control signal.

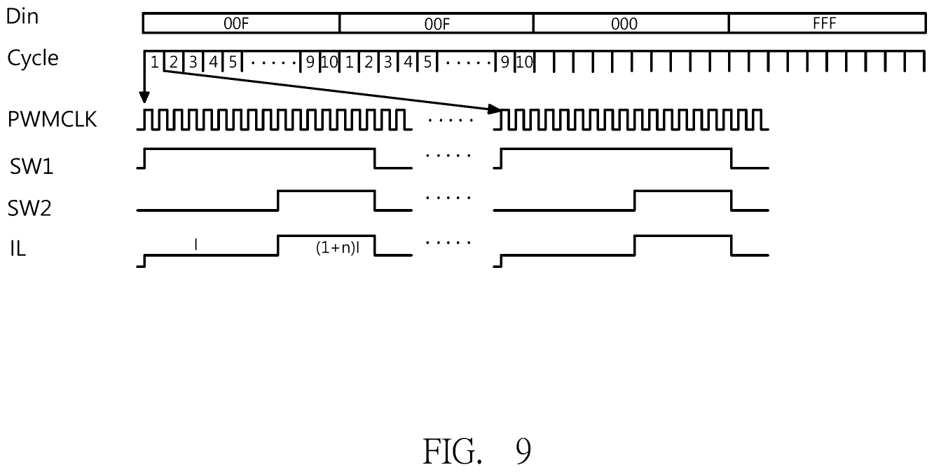

Please refer to FIG. 9, which shows a timing diagram of the driving circuit according to an embodiment of the present application. The difference between the present embodiment and the one in FIG. 4 is that, according to the present embodiment, the current control circuit 90 only outputs the first control signal SW1 to the current generating circuit 99 for generating the first current in the initial stage of each cycle. After the initial stage, the current control circuit 90 outputs the first control signal SW1 and the second control signal SW2 to the current generating circuit 99 for generating the first current and the second current. The total current IL in the initial stage is the first current generated by the current source I. The total current IL after the initial stage is the sum of the first current generated by the current source I and the second current generated by the current source nl. In other words, in the initial stage of each cycle, a low electrical energy method is adopted to drive the display elements.

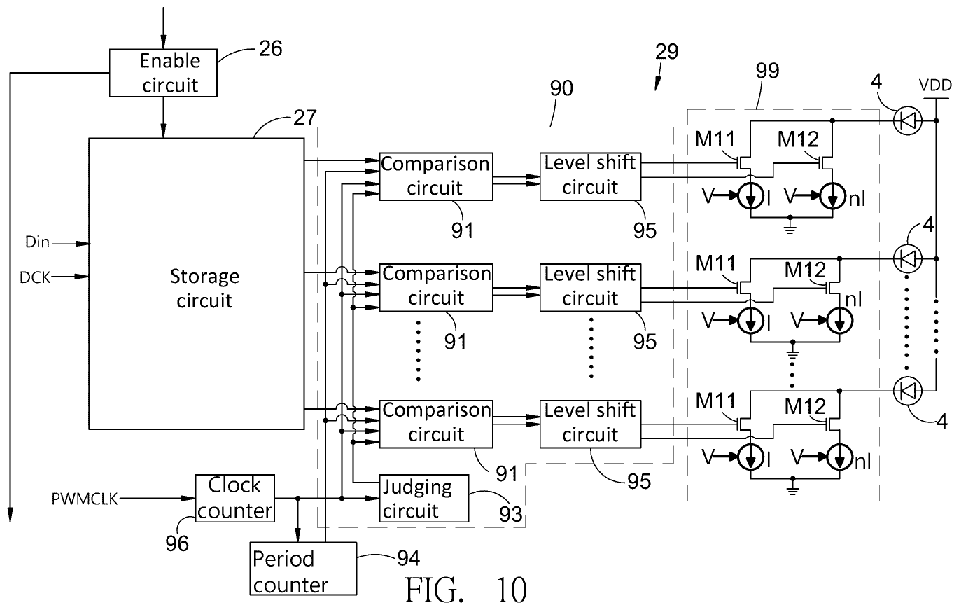

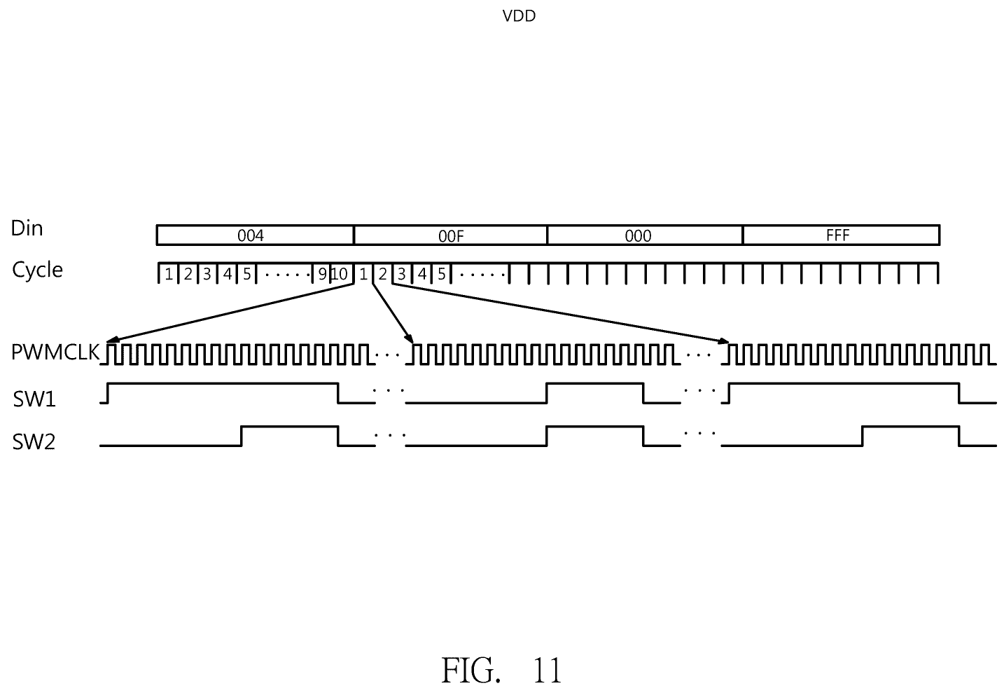

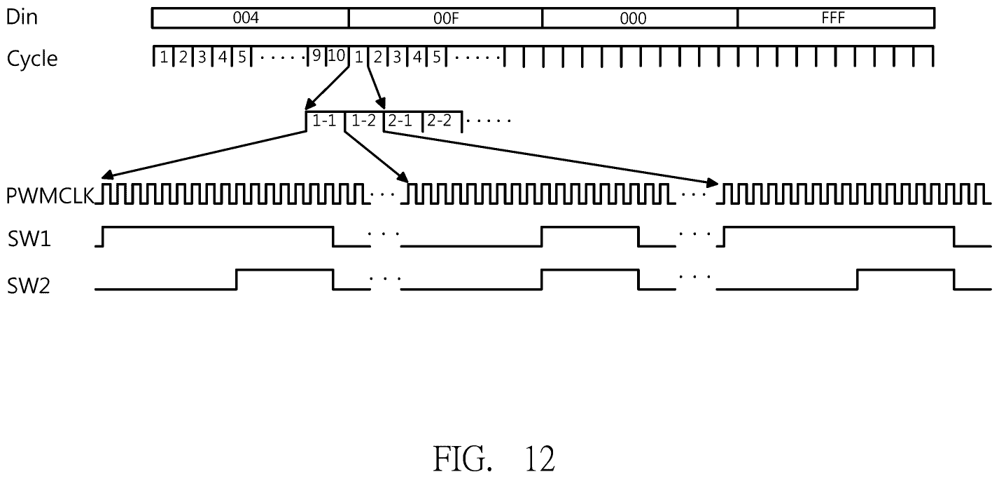

Please refer to FIG. 10, which shows a block diagram of the controller and the driver according to an embodiment of the present application. As shown in the figure, the present embodiment combines the embodiments in FIG. 3 and FIG. 8. As shown in FIG. 11, the current control circuit 90 controls the current generating circuit 99 to generate the first current in the initial stage of one cycle for every two cycles. In the other cycle, the current control circuit 90 does not control the current generating circuit 99 to generate the first current. The current control circuit 90 controls the current generating circuit 99 to generate the first current and the second current after the initial stage. As shown in FIG. 12, each cycle Cycle includes two sub-cycles. The current control circuit 90 controls the current generating circuit 99 to generate the first current in the initial stage of one of the two sub-cycles. The current control circuit 90 controls the current generating circuit 99 to generate the first current and the second current after the initial stage of each sub-cycle.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A driving circuit for display panel, comprising:
a current generating circuit, generating a first current and a second current, and the first current smaller than the second current; and
a current control circuit, controlling the current generating circuit according to a clock signal to generate the first current and the second current;
wherein the current control circuit controls the current generating circuit according to the clock signal to generate the first current in an initial stage, and controls the current generating circuit to generate the first current and the second current after the initial stage.

2. The driving circuit for display panel of claim 1, wherein the current control circuit controls the current generating circuit in a cycle according to the clock signal; the cycle includes the initial stage; the current control circuit controls the current generating circuit to generate the first current in the initial stage of the cycle; and the current control circuit controls the current generating circuit to generate the first current and the second current after the initial stage.

3. The driving circuit for display panel of claim 2, wherein the current control circuit determines a first driving time and a second driving time of the cycle according to pixel data; the first driving time is located in the initial stage of the cycle; the current control circuit controls the current generating circuit to generate the first current in the first driving time; and the current control circuit controls the current generating circuit to generate the first current and the second current in the second driving time.

4. The driving circuit for display panel of claim 3, wherein the current control circuit includes a comparison circuit coupled to the current generating circuit, comparing a counting value of the clock signal and the pixel data for determining the first driving time and the second driving time, controlling the current generating circuit to generate the first current in the first driving time, and controlling the current generating circuit to generate the first current and the second current in the second driving time.

5. The driving circuit for display panel of claim 4, wherein the current control circuit includes a judging circuit coupled to the comparison circuit, and driving the comparison circuit according to a counting value of the clock signal to control the current generating circuit to generate the first current and the second current.

6. The driving circuit for display panel of claim 4, further comprising a clock counter coupled to the comparison circuit, and counting a plurality of clocks of the clock signal for generating the counting value.

7. The driving circuit for display panel of claim 1, wherein the current generating circuit further comprises:
a first current circuit, generating the first current; and
a second current circuit, generating the second current.

8. A driving circuit for display panel, comprising:
a current generating circuit, generating at least one current; and
a current control circuit, controlling the current generating circuit to generate the current in a plurality of cycles according to a clock signal, each cycle including an initial stage, and the current control circuit controlling the current generating circuit to generate the current in the initial stage of a cycle for every N cycles of the plurality of cycles with N greater than 2.

9. The driving circuit for display panel of claim 8, wherein the current control circuit determines a first driving time and a second driving time of each the cycle according to pixel data; the first driving time is located in the initial stage, the current control circuit controls the current generating circuit to generate the current in the first driving time; and the current control circuit controls the current generating circuit to generate the current in the second driving time.

10. The driving circuit for display panel of claim 9, wherein the current control circuit includes a comparison circuit coupled to the current generating circuit, comparing a counting value of the clock signal and the pixel data for determining the first driving time and the second driving time, controlling the current generating circuit to generate the current in the first driving time, and controlling the current generating circuit to generate the current in the second driving time.

11. The driving circuit for display panel of claim 10, further comprising a clock counter coupled to the comparison circuit, and counting a plurality of clocks of the clock signal for generating the counting value.

12. The driving circuit for display panel of claim 8, further comprising a period counter counting the plurality of cycles, and driving the current control circuit to control the current generating circuit to generate the current in the initial stage of one of every N cycles of the plurality of cycles.

13. The driving circuit for display panel of claim 8, wherein the at least one current includes a first current and a second current, the first current is smaller than the second current; the current control circuit controls the current generating circuit to generate the first current in the initial stage of one of every N cycles; and after the initial stage of each cycle, the current control circuit controls the current generating circuit to generate the first current and the second current.

14. The driving circuit for display panel of claim 13, wherein the current control circuit determines a first driving time and a second driving time according to pixel data; the first driving time is located in the initial stage; the current control circuit controls the current generating circuit to generate the first current in the first driving time, and the current control circuit controls the current generating circuit to generate the first current and the second current in the second driving time.

15. The driving circuit for display panel of claim 14, wherein the current control circuit includes a comparison circuit coupled to the current generating circuit, comparing a counting value of the clock signal and the pixel data for determining the first driving time and the second driving time, controlling the current generating circuit to generate the first current in the first driving time, and controlling the current generating circuit to generate the first current and the second current in the second driving time.

16. The driving circuit for display panel of claim 15, wherein the current control circuit includes a judging circuit coupled to the comparison circuit, and driving the comparison circuit according to a counting value of the clock signal to control the current generating circuit to generate the first current and the second current.

17. A driving circuit for display panel, comprising:
a current generating circuit, generating at least one current; and
a current control circuit, controlling the current generating circuit according to a clock signal to generate the current in a plurality of cycles, each the cycle including a plurality of sub-cycles, each sub-cycle including an initial stage, and the current control circuit controlling the current generating circuit to generate the current in the initial stage of one of the plurality of sub-cycles.

18. The driving circuit for display panel of claim 17, wherein the current control circuit determines a first driving time and a second driving time of each the sub-cycle according to pixel data; the first driving time is located in the initial stage, the current control circuit controls the current generating circuit to generate the current in the first driving time; and the current control circuit controls the current generating circuit to generate the current in the second driving time.

19. The driving circuit for display panel of claim 18, wherein the current control circuit includes a comparison circuit coupled to the current generating circuit, comparing a counting value of the clock signal and the pixel data for determining the first driving time and the second driving time, controlling the current generating circuit to generate the current in the first driving time, and controlling the current generating circuit to generate the current in the second driving time.

20. The driving circuit for display panel of claim 19, further comprising a clock counter coupled to the comparison circuit, and counting a plurality of clocks of the clock signal for generating the counting value.

21. The driving circuit for display panel of claim 17, further comprising a period counter counting the plurality of sub-cycles, and driving the current control circuit to control the current generating circuit to generate the current in the initial stage of one of the plurality of sub-cycles.

22. The driving circuit for display panel of claim 17, wherein the at least one current includes a first current and a second current; the first current is smaller than the second current; the current control circuit controls the current generating circuit to generate the first current in the initial stage of one of the plurality of sub-cycles; and after the initial stage of each sub-cycle, the current control circuit controls the current generating circuit to generate the first current and the second current.

23. The driving circuit for display panel of claim 22, wherein the current control circuit determines a first driving time and a second driving time according to pixel data; the first driving time is located in the initial stage; the current control circuit controls the current generating circuit to generate the first current in the first driving time, and the current control circuit controls the current generating circuit to generate the first current and the second current in the second driving time.

24. The driving circuit for display panel of claim 23, wherein the current control circuit includes a comparison circuit coupled to the current generating circuit, comparing a counting value of the clock signal and the pixel data for determining the first driving time and the second driving time, controlling the current generating circuit to generate the first current in the first driving time, and controlling the current generating circuit to generate the first current and the second current in the second driving time.

25. The driving circuit for display panel of claim 24, wherein the current control circuit includes a judging circuit coupled to the comparison circuit, and driving the comparison circuit according to a counting value of the clock signal to control the current generating circuit to generate the first current and the second current.
